(19) United States
(12) Patent Application Publication
(10) Pub. No.: US 2026/0001761 A1
(43) Pub. Date: Jan. 1, 2026

(54) METHOD FOR FLUORINATING HYDROGEN BIS(CHLOROSULFONYL)IMIDE IN GAS PHASE

(71) Applicants: SPECIALTY OPERATIONS FRANCE, Lyon (FR); CENTRE NATIONAL DE LA RECHERCHE SCIENTIFIQUE, Paris Cedex 16 (FR); UNIVERSITE DE POITIERS, Poitiers Cedex (FR)

(72) Inventors: Eric Perin, Pont-Evêque (FR); Sylvette Brunet, Sèvres-Anxaumont (FR); Julien Dieu, Roullet-Saint-Estèphe (FR)

(73) Assignees: SPECIALTY OPERATIONS FRANCE, Lyon (FR); CENTRE NATIONAL DE LA RECHERCHE SCIENTIFIQUE, Paris Cedex 16 (FR); UNIVERSITE DE POITIERS, Poitiers Cedex (FR)

(21) Appl. No.: 18/880,525

(22) PCT Filed: Jun. 23, 2023
(86) PCT No.: PCT/EP2023/067133

§ 371 Date: Dec. 31, 2024

(30) Foreign Application Priority Data
Jul. 1, 2022 (EP) 22305978.3

(51) Int. Cl. C01B 21/086; C01B 21/093; H01M 10/0568

(52) U.S. Cl. CPC C01B 21/086; C01B 21/093; H01M 10/0568; C01P 2006/40; H01M 2300/0025

(57) ABSTRACT

The present invention relates to a method for producing bis(fluorosulfonyl)imide acid, which is economically feasible at industrial scale and which provides a high-purity product.

### CROSS-REFERENCE TO RELATED APPLICATION

This application claims priority to earlier European Patent Application No. 22305978.3, filed on Jul. 1, 2022, the whole content of this application being hereby incorporated by reference for all purposes.

### TECHNICAL FIELD

The present invention relates to a method for producing bis(fluorosulfonyl)imide acid, which is economically feasible at industrial scale and which provides a high-purity product.

### BACKGROUND

Fluorosulfonylimide salts, in particular the lithium salt of bis(fluorosulfonyl)imide (LiFSI), are useful compounds for battery electrolytes. Different processes, reactants and intermediates leading to LiFSI have been described in the patent literature, notably patent CA 2 527 802 (Université de Montréal) which lists several routes to prepare LiFSI, for example the process for preparing LiFSI in one step starting from bis(chlorosulfonyl)imide (HCSI) using anhydrous hydrogen fluoride (HF):

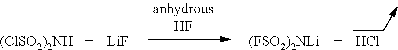

Known in the art are also two-steps processes to prepare LiFSI, such as a process that involves the fluorination of bis(chlorosulfonyl)imide (HCSI) into bis(fluorosulfonyl)imide (HFSI) using a fluorination agent, for example anhydrous hydrogen fluoride (HF), followed by the lithiation of HFSI into LiFSI using a lithiation agent. An example of such a process is disclosed in U.S. Pat. No. 9,725,318, wherein HCSI is reacted with anhydrous HF in the presence of a solvent. The reaction time for obtaining conversion to HFSI is 18 hours.

Another known two-step process for preparing LiFSI involves a first step of fluorination of bis(chlorosulfonyl)imide (HCSI) into ammonium bis(fluorosulfonyl)imide (NH₄FSI) using NH₄F(HF)ₓ as a fluorinating agent, followed by a second step of lithiation of NH₄FSI, leading then to the LiFSI product. Such a process is described for example in WO 2017/090877 A1 (CLS) and EP 3 170 789 A1 (Nippon Soda).

Another known two-step process for preparing LiFSI involves the lithiation of HCSI in a first step using a lithiation agent in order to prepare LiCSI as an intermediate product, and then the fluorination of LiCSI into LiFSI using a fluorination agent. For example, KR 20200049164 (CLS) relates to a LIFSI preparation method, comprising a step reacting HCSI with various lithiation reagents in an (S1) solvent to produce LiCSI and then reacting it with an anhydrous fluorination reagent directly without purification. A long list of possible solvents is given in the specification, while dimethyl carbonate is used in the examples.

US 2017/0183230 discloses a process for converting HCSI to HFSI that comprises reacting liquid HCSI with anhydrous gaseous HF under conditions of temperature and pressure sufficient to produce gaseous HFSI. The yield of HFSI achieved by this process is about 80%, based on conversion of HCSI.

As can be read from the patent literature above-cited, the production of bis(fluorosulfonyl)imide acid takes place in solvents or with HCSI in liquid phase, in order to disperse the reactive entities to allow them to react or to allow recovery of the unreacted species.

The Applicant perceived that there is still the need in the art for improving the manufacturing process of bis(fluorosulfonyl)imide acid.

In particular, the Applicant is well aware that the processes disclosed in the prior art require long reaction time and achieve low level of selectivity.

### SUMMARY OF THE INVENTION

With the aim of overcoming the above drawbacks, the Applicant faced the problem of providing a continuous production process for preparing bis(fluorosulfonyl)imide acid, with low residence time and with a high level of selectivity.

Further, the Applicant addressed environmental aspects of routes to bis(fluorosulfonyl)imide acid, providing a process which would not need the use of hazardous solvents, which would minimise the amount of solid/salt wastes, and which would provide for opportunities of valorization of side products.

Thus, in a first aspect, the present application relates to a method for producing bis(fluorosulfonyl)imide acid (HFSI) comprising the step of contacting gaseous bis(chlorosulfonyl)imide acid (HCSI) with gaseous anhydrous hydrogen fluoride (HF), wherein said method is carried out in the absence of solvent.

The method for manufacturing bis(fluorosulfonyl)imide acid (HFSI) of the present invention is characterised by a high conversion yield and by a high level of selectivity, providing HFSI particularly suited for many applications, notably as an intermediate to prepare LiFSI used in battery applications.

Advantageously, the method of the present invention is carried out in full gas phase. In other words, the method of the present invention is a solvent-free method, which means that no solvent is added to the reaction mixture during the reaction. This is advantageous because first, the step for removing the solvent is avoided, thus reducing the complexity of the industrial process, as well as its overall cost; secondly, the preliminary step of treating the solvent to decrease its moisture content is also avoided. In addition, the side-reactions between HCSI and/or HFSI and the organic solvent are avoided, or at least significantly reduced, increasing the overall yield.

### DETAILED DESCRIPTION

According to the method of the present invention, gaseous HCSI is reacted with anhydrous HF in the gas phase.

HCSI in the gas phase may be obtained from solid or molten HCSI by heating the same to a temperature above HCSI boiling point (Tb_{HCSI}) and/or by HCSI reduced pressure vaporization.

Heating HCSI under whichever pressure (pressure beyond atmospheric pressure; about atmospheric pressure; or reduced pressure) may be accompanied by the use of a carrier gas, such as nitrogen. In such a manner partial pressure of HCSI would be reduced, and vaporization advantageously more effective.

HCSI boiling point (Tb_{HCSI}) as referred above is known to be dependent on the pressure: the boiling point of HCSI or Tb_{HCSI} is hereby used to designate the temperature at which the vapor pressure of HCSI equals the pressure surrounding the liquid/molten HCSI and the liquid/molten HCSI changes into a vapour.

Solid or molten HCSI is commercially available on the market or may be produced by any known method, for example:
by reacting chlorosulfonyl isocyanate (CISO₂NCO) with chlorosulfonic acid (CISO₂OH) (CSI route);
by reacting cyanogen chloride (CNCl) with sulfuric anhydride (SO₃), and with chlorosulfonic acid (CISO₂OH); or
by reacting sulfamic acid (NH₂SO₂OH) with thionyl chloride (SOCl₂) and with chlorosulfonic acid (CISO₂OH) (SFA route).

When solid HCSI is used as starting material, a preliminary step a) of melting solid HCSI to a temperature above its melting temperature (Tm_{HCSI}) to obtain HCSI in a molten state (also called liquid state) is carried out, before heating HCSI to a temperature above its boiling point (Tb_{HCSI}) in step b).

Preferably, step a) is performed at a temperature (Ta) suitable for melting HCSI and maintaining HCSI in the molten state, while its thermal degradation is minimised.

Step a) is conducted at a temperature (Ta) equal to or above the melting point of HCSI (Tm_{HCSI}). In this case, Ta≥Tm_{HCSI}. For example, Ta may be equal to or above the melting point of HCSI (Tm_{HCSI}) plus 5° C. In this case, Ta≥Tm_{HCSI}+5. As another example, Ta may be equal to or above the melting point of HCSI (Tm_{HCSI}) plus 10° C. In this case, Ta≥Tm_{HCSI}+10.

It will be understood that the melting point of HCSI is influenced by the presence and amounts of impurities.

Preferably, the temperature (Ta) at which step a) is conducted is equal to or higher than 30° C., for example equal to or higher than 37° C., for example equal to or higher than 38° C., equal to or higher than 40° C., equal to or higher than 45° C. or even equal to or higher than 50° C. Temperature Ta is preferably lower than 150° C., more preferably equal or lower than 100° C. In any case, the temperature (Ta) at which step a) is conducted is below the degradation temperature of HCSI.

HCSI in liquid state is then further heated to a temperature above its boiling point (Tb_{HCSI}) in step b).

HCSI in liquid state can be suitably vaporised to HCSI in the gas phase by any means known from a person skilled in the art.

As said, each of step a) and/or step b) can be conducted above atmospheric pressure, at atmospheric pressure or under reduced pressure. For example, step a) may be conducted at atmospheric pressure and step b) may be conducted under vacuum at a pressure in the range between 10 to 100000 Pa, preferably between 1000 and 10000 Pa.

Preferably, HCSI in the gas phase is obtained in step b) under reduced pressure, in conditions to reduce the partial pressure of HCSI, such as by heating into a closed vessel, suitably thermostated and/or using a carrier gas.

The said vessel would be selected by one of ordinary skills in the art with appropriate choice of constituent material for being corrosion resistant and compatible with the involved chemicals, which are particularly aggressive because of their acid character.

Loading HCSI in liquid state into the closed vessel can be suitably carried out by cannulation with a carrier gas, in order to avoid any contact with the moisture of air. The expression “cannulation” is not particularly limited and is intended to encompass means which will operate the carrier-gas assisted transfer of HCSI into a reactor. Pumping or other transfer means, e.g. using temperature-controlled pipelines (with set-up to maintain HCSI in liquid state) can advantageously be used. HCSI in liquid state is also kept in an anhydrous atmosphere in the vessel. A suitable carrier gas for cannulation is nitrogen or argon.

HCSI in the gas phase may be then loaded into the closed reactor for contacting with gaseous anhydrous HF.

HCSI in the gas phase may be loaded into the closed reactor as it is.

Alternatively, HCSI in the gas phase may be loaded into the closed reactor as a mixture with a carrier gas [(mixture (M1)], wherein said mixture (M1) can be obtained by bubbling a carrier gas into the HCSI in the gas phase and kept at a temperature above its boiling point. Carrier gas to be bubbled into the closed vessel can be the same gas used for cannulation, or can be a different gas.

The term “carrier gas” as used in the process of the present invention is intended to mean any chemically stable and dry gas, with a moisture content not higher than 100 ppm.

Mixture (M1) may also be obtained by sweeping with a carrier gas the head space over liquid HCSI. In such mixture (M1), partial pressure of HCSI vapours will be below the vapour tension of HCSI at the temperature of the mixture (M1): in other terms, HCSI in the said mixture will be at a temperature above its boiling point (Tb_{HCSI}) in the conditions of pressure in mixture (M1).

The carrier gas for use in the preparation of mixture (M1) is preferably nitrogen.

HCSI in the gas phase or the mixture (M1) comprising HCSI in the gas phase may be added into the closed reactor for being contacted with gaseous HF either progressively or at once.

It is understood that HCSI in the gas phase might comprise impurities generated during heating steps a) or b), or impurities already present in the solid or molten HCSI starting material, without these impairing its properties.

HCSI in the gas phase has a purity of at least 95%, preferably of at least 98%, more preferably of at least 99.5%.

Gaseous anhydrous hydrogen fluoride (HF) can be suitably introduced into the closed reactor by injection.

At atmospheric pressure, the boiling point of HF is 19.5° C. Thus, in order to obtain anhydrous HF in gas phase, liquid anhydrous HF may be pre-heated in a suitable apparatus that keeps anhydrous HF in gas phase and is connected with the reactor through a proper system of injection suitably thermostated to maintain anhydrous HF in the gas phase.

HF may be provided to the reactor at a temperature ranging from 19.5° C. to 200° C., preferably at a temperature of 19.5° C. to 150° C.

Addition of gaseous anhydrous HF may be carried out continuously or semi-continuously.

Typically, gaseous anhydrous HF is continuously added or added in a controlled manner throughout the reaction time at a substantially constant rate.

Gaseous anhydrous HF can be provided to the reactor as it is. Alternatively, gaseous anhydrous HF can be diluted with a carrier gas, and provided to the reactor in the gas phase in admixture with the carrier gas [mixture (M2)].

The carrier gas for use in the preparation of mixture (M2) is preferably nitrogen; generally anhydrous nitrogen is used.

According to a preferred embodiment of the invention, the reaction between HCSI and gaseous anhydrous HF is thus carried out in a closed reactor in the presence of a carrier gas deriving from mixture (M1) and/or from mixture (M2).

Additional carrier gas may be directly fed into the reactor.

A purging gas can be optionally used to flush the reactor without any of the previously cited streams being introduced. It can be the same gas a for step b), as well as for the carrier gas for use in the preparation of mixture (M2)

The molar ratio between HCSI and the anhydrous HF is preferably between 1:1 and 1:3, preferably between 1:1 and 1:2.5. Yet, good results have been obtained using a more significant excess of HF; molar ratios of 1:1 to 1:30 are effective, and a ratio of 1:10 to 1:25 has provided advantages. The choice of the preferred molar ratio will be made by one of ordinary skills in the art considering various parameters, including the need for recycling excess of HF, and the kinetics/yield dependence upon the said HCSI:HFSI ratios.

Similarly, without this being exhaustive, the molar ratio between HCSI and the total amount of carrier gas in the reactor mixture may be preferably between 1:3 and 1:30, preferably between 1:3 and 1:15.

The reaction between HCSI and anhydrous HF in the gas phase generally takes place in a closed reactor at temperature and pressure conditions that are suitable for keeping all the reactants and carrier gas into the gas phase.

Typically, the reaction is carried out into a closed reactor at a temperature of from 100 to 300° C., more preferably from 160 to 220° C., still more preferably from 160 to 180° C.

Residence time of the reactants in the closed reactor is preferably between 10 seconds to 3 hours.

The reaction conditions are maintained such that the HFSI produced is removed from the reaction mixture as a gas.

Produced HFSI may be extracted in admixture with another gas, e.g. in admixture with unreacted HF, carrier gas, unreacted HCSI, etc., generally referred as a gaseous reaction mixture.

At the end of the reaction, HFSI is separated from the gaseous reaction mixture by condensation, while the other gaseous products, such as HCl and HF, remain in the gas phase, thereby providing ease of purification of HFSI.

According to certain embodiments, the excess gaseous products, such as unreacted HF and HCl can be separated by any method known in the art, such as distillation or stripping. HF may be advantageously recovered for reuse in the fluorination of HCSI.

The embodiments described allow direct conversion of HCSI to HFSI with anhydrous HF in a high-atom efficiency approach that enables continuous fluorination with good to excellent yield and reduced environmental impact (mostly valorizable gaseous effluents).

The method according to the present invention advantageously provides a high conversion of HSCI to HFSI, with yields above 90%, preferably above 95%, and more preferably above 99%.

HFSI isolated after the end of the reaction may include some impurities, such as fluorosulfuric acid. Such fluorosulfuric acid can be in an amount ranging from 0 to 10% by moles. In preferred embodiments of the present invention, the amount of impurities in HFSI is lower than 1% by moles.

Furthermore, the method according to the present invention advantageously provides HFSI with a high level of conversion and selectivity, in a molar yield which may be as high as >90%, and even higher than 99%, which makes it particularly suited for many applications, notably as an intermediate to prepare LiFSI used in battery applications.

A further advantage of the present invention is that the above mentioned high level of conversion and high level of selectivity are obtained without the need to add catalyst(s), thus reducing the operating costs and expenses of the process.

The present invention thus provides a method for producing a bis(fluorosulfonyl)imide acid (HFSI) comprising the step of contacting gaseous bis(chlorosulfonyl)imide acid (HCSI) with gaseous anhydrous hydrogen fluoride (HF), wherein said method is carried out in the absence of solvent and in the absence of added catalyst, such as cobalt oxides, nickel oxides, molybdenum oxides and mixtures thereof, which can be supported or not supported for example on silica, alumina or active charcoal. This leads to a more sustainable and economically viable process.

In another object, the present invention thus provides bis(fluorosulfonyl)imide acid (HFSI) obtainable by the method as above defined.

All raw materials used in the method according to the invention, including reactants, may preferably show very high purity criteria. Preferably, their content of metal components such as Na, K, Ca, Mg, Fe, Cu, Cr, Ni, Zn, is below 10 ppm, more preferably below 5 ppm, or below 2 ppm.

The bis(fluorosulfonyl)imide acid (HFSI) as obtained at the end of the process of the present invention can be advantageously used as such for other reactions or optionally further purified by any means known from a skilled person, including distillation, crystallisation, etc.

HFSI obtained by the process of the present invention may also be salified by subjecting it to a cation exchange step in order to obtain alkali metal salts, alkaline-earth metal salts or quaternary ammonium cation salts, suitable for use in secondary batteries.

Consistently, the present invention further pertains to a method of making an alkali metal salt, an alkaline-earth metal salt or a quaternary ammonium cation salt of HFSI, said method comprising:
a. producing bis(fluorosulfonyl)imide acid (HFSI) via a method comprising the step of contacting gaseous bis(chlorosulfonyl)imide acid (HCSI) with gaseous anhydrous hydrogen fluoride (HF), wherein said method is carried out in the absence of solvent, and
b. salifying the so obtained HFSI.

According to a preferred embodiment, HFSI is salified with a lithium salt to provide direct lithiation of HFSI to lithium bis(fluorosulfonyl)imide (LiFSI) according to methods known to the person skilled in the art.

Advantageously, the lithium bis(fluorosulfonyl)imide (LiFSI) prepared according to the method of the present invention can be used in an electrolyte composition for an electrochemical cell.

In a further aspect, the present invention pertains to an electrolyte composition comprising the LiFSI as obtained with the method of the present invention. advantageously, said electrolyte composition is a non-aqueous electrolyte composition.

Some of the steps or all steps of the method according to the invention are advantageously carried out in equipment capable of withstanding the corrosion of the reactants, reaction medium and products.

For this purpose, materials are selected for the part in contact with the reaction medium that are corrosion-resistant, such as the alloys based on molybdenum, chromium, cobalt, iron, copper, manganese, titanium, zirconium, aluminium, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass and glass-lined as well as enamel equipment may also be used. Furthermore, corrosion-resistant silicon carbide (or SiC) materials can be advantageously used. It will not be outside the scope of the invention to use an equivalent material (tungsten carbide, etc).

The invention will be now described with reference to the following examples, whose purpose is merely illustrative and not intended to limit the scope of the invention.

### EXPERIMENTAL SECTION

### Raw Materials

Bis(chlorosulfonyl)imide acid (HCSI), synthesised through CSI or SFA route. Anhydrous HF, commercially available from Solvay.

HCSI was melted and then loaded into an autoclave by argon cannulation to avoid any contact with the moisture of the air. The autoclave was placed in an oven to maintain the temperature at 155° C. In a second oven before the reactor the temperature was fixed at 155° C. In the autoclave, a flow of 3.2 l/h of nitrogen bubbling in the liquid allows to bring to the reactor the gas phase containing a mixture of nitrogen and HCSI.

In parallel, anhydrous HF was injected in the gas phase into the reactor. To obtain this gas phase, the bottle of anhydrous HF was placed in a first oven at 54° C. A second oven containing the nozzle and the valves was heated at 72° C. The gas phase mixture comprising HCSI and the anhydrous HF were diluted with a co feeding of nitrogen just before the inlet of the reactor. This reactor was placed in a closed cabinet and heated with an electrical jacket.

At the outlet, the products were neutralized with an aqueous solution of KOH. The products resulting from the reaction were analysed by ¹⁹F NMR.

The results of trials carried out at different temperatures, ranging from 160° C. to 220° C., done with 4.5 g of HCSI, with the following molar ratio: HCSI/HF/N₂: 1/11/15, are reported in Table1.

TABLE 1

| Trial | Reactor T | Molar FSI⁻ | Molar FSO₃⁻ | Molar Cl⁻ |
|---|---|---|---|---|
| No. | (° C.) | yield (%) | yield (%) | yield (%) |
| 1 | 160 | 91 | 7 | 98 |
| 2 | 180 | 90 | 7 | 98 |
| 3 | 200 | 77 | 8 | 98 |
| 4 | 220 | 77 | 6 | 98 |

1. A method for producing bis(fluorosulfonyl)imide acid (HFSI), said method comprising the step of contacting gaseous bis(chlorosulfonyl)imide acid (HCSI) with gaseous anhydrous hydrogen fluoride (HF), wherein said method is carried out in the absence of solvent.

2. The method according to claim 1, wherein gaseous HCSI is obtained from solid or molten HCSI by heating the same to a temperature above HCSI boiling point (TbHCSI) and/or by HCSI reduced pressure vaporization.

3. The method according to claim 1, wherein gaseous HCSI is obtained from HCSI in liquid state by a two steps procedure comprising:
a) melting solid HCSI to a temperature above its melting temperature (Tm_{HCSI}); and
b) further heating to a temperature above its boiling point (Tb_{HCSI}).

4. The method according to claim 1, wherein gaseous HCSI is loaded into a closed reactor for contacting with gaseous anhydrous HF in admixture with a carrier gas [mixture (M1)].

5. The method according to claim 1, wherein gaseous anhydrous HF is loaded into the closed reactor for contacting with gaseous HCSI in admixture with a carrier gas [mixture (M2)].

6. The method according to claim 4, wherein the carrier gas is nitrogen.

7. The method according to claim 1, wherein the molar ratio between HCSI and the anhydrous HF is between 1:1 and 1:3.

8. The method according to claim 1, wherein contacting the HCSI and gaseous anhydrous HF is carried out in a closed reactor in the presence of carrier gas deriving from a mixture (M1) and/or from a mixture (M2) and wherein the ratio between HCSI and a total amount of carrier gas in the reactor mixture is between 1:3 and 1:30.

9. The method according to claim 1, wherein the step of contacting gaseous HCSI with gaseous anhydrous HF is carried out in a closed reactor at a temperature of from 100 to 300° C.

10. The method according to claim 1, wherein the residence time of the HCSI and the anhydrous HF in the closed reactor is between 10 seconds to 3 hours.

11. A method of making an alkali metal salt, an alkaline-earth metal salt or a quaternary ammonium cation salt of HFSI, said method comprising:
(a) producing bis(fluorosulfonyl)imide acid (HFSI) via a method comprising the step of contacting gaseous bis(chlorosulfonyl)imide acid (HCSI) with gaseous anhydrous hydrogen fluoride (HF), wherein said method is carried out in the absence of solvent, and
(b) salifying the so obtained HFSI.

12. The method according to claim 11, wherein the step of salification of HFSI is carried out with a lithium salt so as to provide lithium bis(fluorosulfonyl)imide (LiFSI).

13. A bis(fluorosulfonyl)imide acid (HFSI) obtained by the method according to claim 1.

14. A lithium bis(fluorosulfonyl)imide (LiFSI) obtained by the method according to claim 11.

15. A method comprising incorporating the lithium bis(fluorosulfonyl)imide (LiFSI) according to claim 14 in a non-aqueous electrolyte for batteries.

16. An electrolyte composition comprising the lithium bis(fluorosulfonyl)imide (LiFSI) according to claim 15.
